(19) United States
(12) Patent Application Publication
(10) Pub. No.: US 2022/0089079 A1
(43) Pub. Date: Mar. 24, 2022

(54) CONTOURED SHIPPING CRADLE

(71) Applicant: Performance Specialized Services, LLC, Petal, MS (US)

(72) Inventors: Matthew Roberts, Petal, MS (US); Mark Graves, Flower Mound, TX (US)

(73) Assignee: Performance Specialized Services, LLC, Petal, MS (US)

(21) Appl. No.: 17/478,575

(22) Filed: Sep. 17, 2021

Related U.S. Application Data
(60) Provisional application No. 63/080,535, filed on Sep. 18, 2020.

(51) Int. Cl. B60P 7/08; B65D 88/12

(52) U.S. Cl. CPC B60P 7/08; B60P 7/0823; B65D 88/129

(57) ABSTRACT

A system and method for transporting building materials is provided. The system generally comprises end units and interior units having bolster assemblies and cradles. The bolster assembly preferably comprises a beam, D-rings, and a plurality of attachment plates configured to allow for the attachment of a cradle having a shape configured to securely fit the shape of a building material. Two or more end units of the system may be secured to a transport vehicle, such as a railcar, and building materials may be placed within the cradles, thus stabilizing the building materials and protecting them from damage. Two or more interior units may then be used to create layers of building materials before being topped with two or more end units. A securing member may be used to fasten the end units and interior units to one another, which secures the one or more layers of building materials to the transport vehicle in a way that will prevent shifting of the building materials during transport.

This application claims the benefit of U.S. Provisional Application No. 63/080,535, filed on Sep. 18, 2020, which application is incorporated herein by reference.

### FIELD OF THE DISCLOSURE

The subject matter of the present disclosure refers generally to a system and method for transporting building materials.

### BACKGROUND

Pipes used for construction can be difficult to transport. In fact, pipe is a leading derailment commodity throughout the world, and as such, is subject to additional oversight during transportation, which increases cost and time to transport. If not for this additional oversight, however, the danger of derailments would be too great to railroad workers and general population. Therefore, standards set by organizations such as the Association of American Railroads are necessary to decrease risk associated with transporting risky building materials such as pipes. Unfortunately, current methods of transporting pipes differ little than methods used a couple of decades ago, which means that railroad transportation technology has not evolved in a way that has greatly reduced the cost and danger of transporting pipe over long distances during that time.

The reason for derailment during the transport of pipe occurs most often due to excessive load shift caused by dunnage failure or improper securement of pipe to a transport vehicle. Currently, wood is the most often used dunnage material for the transport of pipe, and the blocking techniques used do not always keep pipe securely in place. In addition, wood dunnage must be discarded after two uses, and because wood is not recyclable, this greatly increase the cost of transporting pipe over long distances. Further, because useful life of wood dunnage is so low, inspections must be performed whenever a load of pipe is transformed from one transport vehicle to another. This means that the cross-country transfer of pipe must undergo multiple inspections, which greatly decreases the efficiency of the transport.

Accordingly, there is a need in the art for a contoured shipping cradle designed to eliminate load shift currently experienced during the transport of pipes, which will subsequently reduce inspection requirements, cost, and the danger of pipe transportation while simultaneously increasing the efficiency.

### SUMMARY

A system for a system and method for transporting building materials is provided. In one aspect, the system of the present disclosure is designed to secure building material to a vehicle. In another aspect, the system of the present disclosure is designed to create secured shipping mass that may be transported over long distances. Generally, the system of the present disclosure allows a user to safely secure building materials, such as pipes, to a flatcar in a way that allows the user to eliminate traditional wood dunnage. The system generally comprises a bolster assembly and a cradle.

The bolster assembly comprises a beam, D-rings, and a plurality of attachment plates configured to allow for the attachment of a cradle. The attachment plates comprise a combination of end plates, gusset plates, and stiffener plates. The bolster assembly is preferably constructed from a metallic material, including but not limited to, carbon steel, stainless steel, aluminum, or any combination thereof. Attachment holes extending through the attachment plates allow for the cradle to the bolster assembly. A plurality of stake pocket tie-down anchors and stake pockets may be used to secure the bolster assembly to a vehicle. The cradle is sized such that it fits snuggly between the attachment plates and against the beam of the bolster assembly. The cradle comprises a plurality of formed spaces that are shaped in a way such that said formed spaces may snuggly enfold the contour of a building material placed therein. In some preferred embodiments, bolster assembly adapters may be secured to a vehicle so that bolster assemblies may be removably secured thereto.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTON OF THE DRAWINGS

These and other features, aspects, and advantages of the present disclosure will become better understood with regard to the following description, appended claims, and accompanying drawings where:

FIG. 1 is a perspective view of a contoured shipping container as described herein.

FIG. 2 is a front view of a contoured shipping container as described herein.

FIG. 3 is a back view of a contoured shipping container as described herein.

FIG. 4 is a bird's eye view of a contoured shipping container as described herein.

FIG. 5 is a view of the contoured shipping container forming a secured shipping mass as described herein.

FIG. 6 is a flow chart illustrating certain method steps embodying features consistent with the principles of the present disclosure.

FIG. 7 is a bird's eye view of a bolster assembly adapter as described herein.

FIG. 8 is a side view of a bolster assembly adapter as described herein.

### DETAILED DESCRIPTION

In the Summary above and in this Detailed Description, and the Claims below, and in the accompanying drawings, reference is made to particular features, including process steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally. Where reference is made herein to a process comprising two or more defined steps, the defined steps can be carried out in any order or simultaneously (except where the context excludes that possibility), and the process can include one or more other steps which are carried out before any of the defined steps, between two of the defined steps, or after all the defined steps (except where the context excludes that possibility).

The term “comprises” and grammatical equivalents thereof are used herein to mean that other components, steps, etc. are optionally present. For instance, a system “comprising” components A, B, and C can contain only components A, B, and C, or can contain not only components A, B, and C, but also one or more other components. The term “at least one of . . . and” and grammatical equivalents thereof are used herein to mean that at least one of a group of items is present but more components of that group can be present. For instance, a system comprising at least one of components A, B, and C can contain only components A and B, or can contain multiple components A and C, but only one of component B.

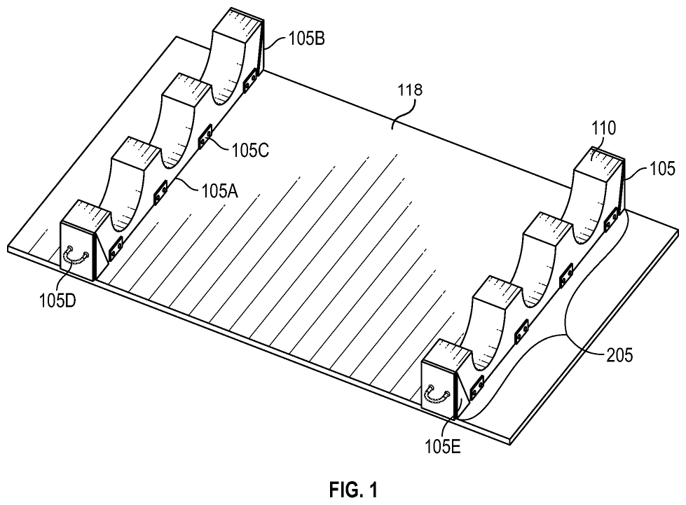

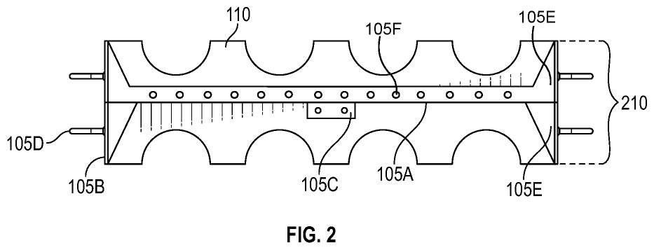

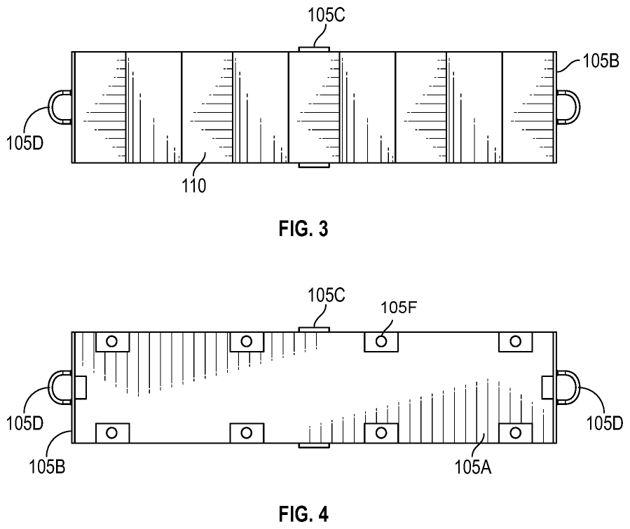

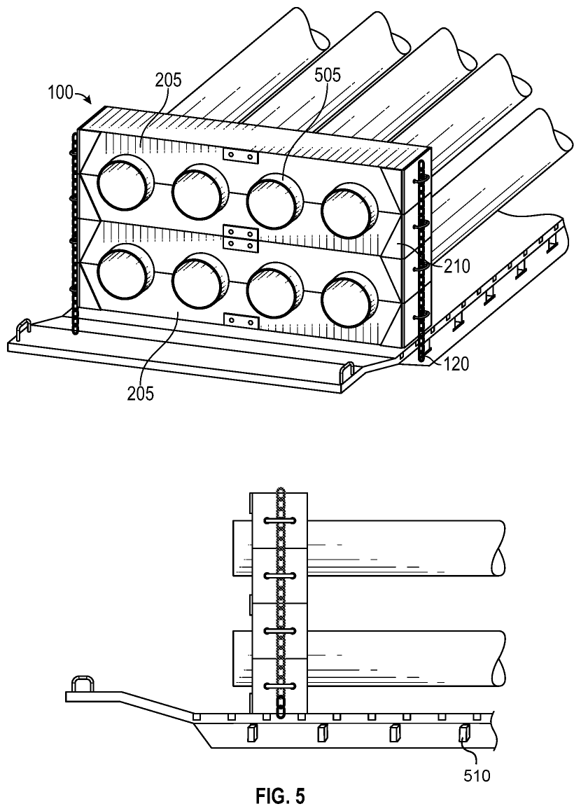

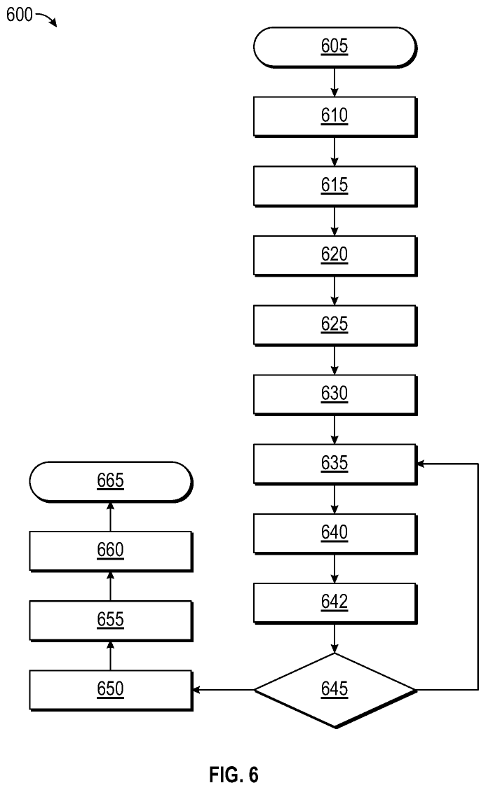

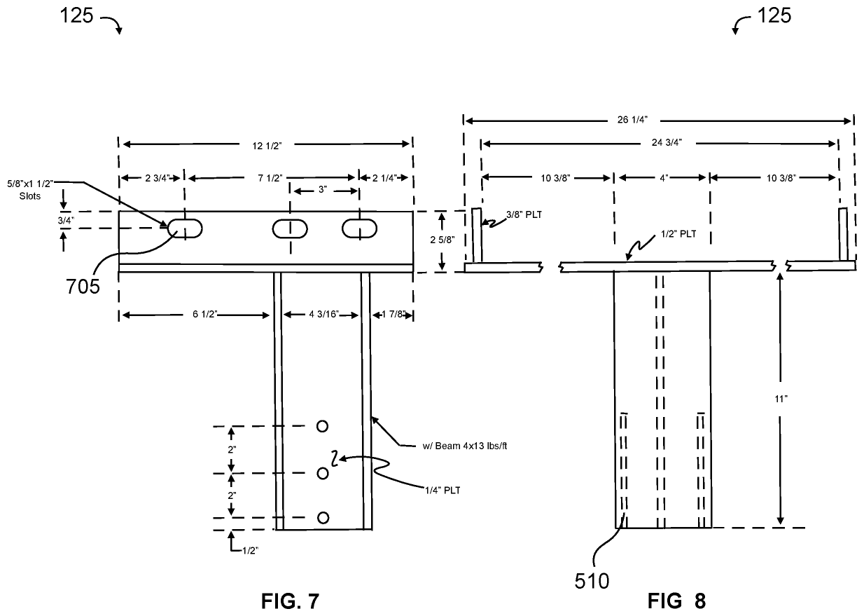

FIGS. 1-8 illustrate embodiments of a contoured shipping cradle used to transport building materials 505. The system 100 generally comprises a bolster assembly 105 and cradle 110. As illustrated in FIG. 1, the system 100 may be incorporated into a vehicle's body. Alternatively, the system 100 may be removeable attached to a vehicle, as illustrated in FIG. 3, or with the use of a bolster assembly adapter, as illustrated in FIGS. 7 and 8. FIG. 1 illustrates a front perspective view of a beam 105A having attachment plates 105B, 105C that extend to one of a bottom surface or top surface of the beam 105A (end unit 205). FIG. 2 illustrates a front perspective view of a beam 105A having attachment plates 105B, 105C that extend past both a bottom surface and top surface of the beam 105A (interior unit 210). FIG. 3 illustrates a top view of a beam 105A having attachment plates 105B, 105C that extend past the top surface of the beam 105A. FIG. 4 illustrates a bottom view of a beam 105A having attachment plates 105B, 105C that extend to the top surface of the beam 105A. FIG. 5 illustrates the system 100 used in conjunction with building materials 505 to form a secured shipping mass. FIG. 6 illustrates a method that may be carried out by a user using the system 100. It is understood that the various method steps associated with the method of the present disclosure may be carried out by a user using the system 100 shown in FIGS. 1-5. FIG. 7 illustrates a bird's eye view of a bolster assembly adapter 125 and slots 705 used to secure bolster assemblies 105 thereto. FIG. 8 illustrates a side view of a bolster assembly adapter 125 and how said bolster assembly adapter 125 may be secured to flatbeds 118 using stake pockets 510.

The bolster assembly 105 comprises a beam 105A, D-rings 105D, and a plurality of attachment plates 105B, 105C configured to allow for the attachment of a cradle 110. The attachment plates are preferably permanently secured to the beam 105A via a weld. Alternatively, the attachment plates and beam 105A may be cast in a way to create a single piece. In a preferred embodiment, the attachment plates may comprise end plates 105B and gusset plates 105C, which may extend to the top surface and/or bottom surface of the beam 105A. Stiffener plates 105E may be secured to the end plates 105B and beam 105A in a way that increases the structural integrity of the bolster assembly 105, as illustrated in FIGS. 1 and 2. In some preferred embodiments, the stiffener plates 105E extend from one end plate 105B to another end plate 105B. The bolster assembly 105 is preferably constructed from a metallic material, including but not limited to, carbon steel, stainless steel, aluminum, or any combination thereof. The thickness of the beam 105A is preferably thick enough to provide structural stability when moved from one vehicle to another. For instance, a bolster assembly 105 constructed of carbon steel preferably comprises a beam 105A and attachment plates 105B, 105C having thicknesses of about ⅝ of an inch, which may prevent the beam 105A and attachment plates 105B, 105C from deforming when securing a plurality of pipes to a vehicle.

In some preferred embodiments, attachment holes 105F extending through the beam 105A allow for the system 100 to be secured to a vehicle. For instance, a bolster assembly 105 having a plurality of attachment holes 105F in the beam 105A may allow for attachment to a rail car using a plurality of bolts, wherein the plurality of attachment holes 105F in the beam 105A are configured to align with a plurality of apertures of the rail car such that the plurality of bolts may secure the bolster assembly 105 thereto. In another preferred embodiment, a plurality of stake pocket tie-down anchors and stake pockets 510 may be used to secure the bolster assembly 105 to a vehicle. For instance, a flatbed semitruck trailer may comprise a plurality of stake pockets 510 configured to receive a plurality of stake pocket tie-down anchors of a bolster assembly 105. Once the stake pocket tie-down anchors are secured within the stake pockets 510, a locking element may be used to prevent the anchors from coming undone. Apparatuses that may act as the locking element include, but are not limited to, push-pull pins, clamps, set knobs, snap locks, spring buttons, clutch locks, combination locks, or any combination thereof.

The cradle 110 is sized such that it fits snuggly between the attachment plates 105B, 105C and against the beam 105A. The cradle 110 comprises a plurality of formed spaces 115 that are shaped in a way such that said formed spaces 115 may snuggly enfold the contour of the building material 505 placed therein. Attachment holes 105F of the attachment plates 105B, 105C allow for the securement of the cradle 110 to the bolster assembly 105, as illustrated in FIGS. 1 and 2. The cradle 110 preferably extends above the attachment plates 105B, 105C to eliminate the possibility of the bolster assembly 105 contacting the building material 505 secured by the cradle 110. The material used to construct the cradle 110 preferably has a Brinell Hardness Number of 12 or less. In another preferred embodiment, the material used to construct the cradle 110 has a tensile strength greater than 25 MPa. Materials that may be used to construct the cradle 110 include, but are not limited to, polymer, wood, compressed fiber, or any combination thereof. In a preferred embodiment, the material used to construct the cradle 110 is a recyclable polymer, such as thermoplastics. The use of recyclable thermoplastics will allow for cradles 110 that have been damaged (or gone past their useful life) to be melted and recast, which will reduce waste and ultimately reduce cost.

When using the system 100 to secure building materials 505 to a vehicle, at least two end units 205 having attachment plates 105B, 105C extending only to the top surface of the beam 105A are place in a way such that when the building material 505 is placed thereon, the building material 505 fits snuggly within the formed spaces 115 of the cradles 110. Because building materials 505 may not have the same shape over its entire length, the formed spaces 115 of the cradles 110 of the at last two bases units 205 may differ in a way such that they may snuggly fit the respective section of the building material 505 that will be placed therein. For instance, two end units 205 configured to secure a tapered pipe may have cradles 110 comprising formed spaces 115 that are contoured in way that fits the diameter of the tapered pipe at the respective point in which the end units 205 are configured to secure the tapered pipes. Therefore, a first end unit 205 may comprise formed spaces 115 that are configured to fit a larger diameter of the tapered pipe than the second end unit 205, or vice versa. Other embodiments of the system 100 may require more than two end units 205.

Once building materials 505 have filled the formed spaces 115 of the cradles 110 of the end units 205, interior units 210 may be placed on top of the building materials 505 in a way such that the formed spaces 115 of the cradles 110 of the interior units 210 snuggly fit the contours of the building materials 505. The interior units 210 are preferably placed directly above the end units 205. Because the interior units 210 comprise attachment plates 105B, 105C that extend from the top surface and bottom surface, interior units 210 have cradles 110 attached to both the top surface and bottom surface, allowing for building materials 505, especially pipes, to be placed within the formed spaces 115 of the top cradle 110 once the formed spaces 115 of the bottom cradle 110 have been snuggly fit to the building materials 505 below. This process may be repeated to create multiple layers of building materials 505 that may then be topped with a end unit 205 with the cradle 110 positioned such that the formed spaces 115 face the cradles 110 of the end units 205 attached to the vehicle.

A securing member 120 may be threaded through the D-rings 105D on the ends of the bolster assemblies 105, which may allow the bolster assemblies 105 to be secured to one another. In a preferred embodiment, the securing member is a chain or polyester strapping, as illustrated in FIG. 5. This will further prevent movement of the building materials 505 since the added pressure will increase the friction force acting on the building materials 505 within the cradles 110. In some preferred embodiment, the securing members 120 may additionally be secured to the vehicle, which may provide multiple anchor points for securely attaching the various units to the vehicle. The D-ring 105D preferably has weight rating of at least 50 tons.

As illustrated in FIGS. 7 and 8, some embodiments of the system 100 may further comprise a bolster assembly adapter 125, which is configured to attach to a flatbed 118 of a vehicle. The bolster assembly adapters 125 are preferably made of steel. In a preferred embodiment, the bolster assembly adapters 125 attach to the flatbed 118 via stake pockets 510 on the sides of the flatbed 118. For instance, the bolster assembly adapter 125 may be configured to bolt to stake pockets 510 of a flatcar so that bolster assemblies 105 may be attached to the flatcar without welding or some other permanent means. The bolster assembly adapters 125 are configured to run length wise with the flatbed 118 such that bolster assemblies 105 may be attached perpendicularly down the length of said flatbed 118 to said bolster assembly adapters 125. In a preferred embodiment, bolster assemblies 105 may further comprise slots 705. Bolster assemblies 105 may be attached to the bolster assembly adapters 125 via slots 705 of said bolster assembly adapters 125. A securing member 122 may be used to secure said bolster assembly 105 to said bolster assembly adapter 125. In one preferred embodiment, a chain may be used to secure a bolster assembly 105 to the flatbed 118 via the D-rings of the bolster assembly 105 and slots 705 of the bolster assembly adapter 125. In another preferred embodiment, an end unit 205 may be bolted to the bolster assembly adapters 125. For instance, attachment holes 105F in the beam of the bolster assembly 105 may be used to secure the bolster assembly to slots 705 of the bolster assembly adapter 125 using bolts. In yet another preferred embodiment, bolster assembly adapters 125 may be welded to the ends of the bolster assemblies 105 such that attaching and detaching the bolster assembly adapter 125 from the stake pockets 510 of the flatbed 118 allows one to attach and detach bolster assemblies 105.

FIG. 6 provides a flow chart 600 illustrating certain, preferred method steps that may be used to carry out the process of stacking pipes on a vehicle using the system 100. Step 605 indicates the beginning of the method. During step 610, a user may obtain at least four end units 205, two for the base and two for the top, and at least two interior units 210. Once acquired, the user may obtain vehicle configured to allow for attachment said end units 205 during step 615. In a preferred embodiment, an 89′ flat car may be used as the vehicle to which the end units 205 are attached. The user may then proceed to attach the end units 205 to the vehicle during step 620. The end units 205 are preferably attached to the vehicle via bolts, welds, or stake pockets 510. In some preferred embodiments, a user may need to determine in what way the end units 205 should be attached to the vehicle. For instance, a user using more than two end units 205 to form the base will need to space the end units 205 differently than a user using more than two end units 205 to form the base.

Once the end units 205 have been attached to the vehicle, the user must obtain the building materials 505 that will be placed in the cradles 110 of the end units 205 during step 625. After obtaining the building materials 505, the user may place the building materials 505 in the cradles 110 during step 630. The user may then place the cradles 110 on the bottom side of the interior units 210 on top of the building materials 505 and above the end units 205 during step 635. Once secured around the building materials 505 below, the user may place building materials 505 within the cradles 110 on the top side of the interior units 210 during step 640. The user may then perform a query to determine if another layer of interior units 210 should be placed on top of the current layer of building materials 505 during step 642. Based on the results of that query, the user may take an action during step 645. In a preferred embodiment, a user may determine that another layer of interior units 210 is necessary when there are additionally building materials 505 in need of transport and the total height of the system 100 and building materials 505 will be less than 14 feet when a end unit 205 is used as a top layer.

If a user determines that another layer of interior units 210 is necessary, the user may proceed to step 635. If a user determines that another layer of interior units 210 is not necessary, the user may proceed to step 650, wherein the user may place the remaining end units 205 on top of the highest layer of building materials 505 and directly above the highest layer of interior units 210. The user may then obtain a securing member 120 during step 655 and subsequently use said securing member 120 to secure the end units 205 and interior units 210 to the vehicle during step 660. In a preferred embodiment, the securing member 120 is a chain, and a first end of the chain is secured to the vehicle and the chain is then threaded through the D-rings 105D of the bolster assemblies 105. The chain is then pulled taut, and a second end of the chain is secured in a way such that the chain is prevented from loosening, which secures the various units and building materials 505 to the vehicle. Once the securing member 120 is secured, the method may then proceed to the terminate method step 665.

Although the systems and processes of the present disclosure have been discussed for use within the pipe transportation attachment field, one of skill in the art will appreciate that the inventive subject matter disclosed herein may be utilized in other fields or for other applications in which the transport of building materials is needed. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flow depicted in the accompanying figures and/or described herein do not necessarily require the particular order shown, or sequential order, to achieve desirable results unless otherwise stated. It will be readily understood to those skilled in the art that various other changes in the details, materials, and arrangements of the parts and process stages which have been described and illustrated in order to explain the nature of this inventive subject matter can be made without departing from the principles and scope of the inventive subject matter.

What is claimed is:

1. A system for securing a building material comprising:
a cradle having a plurality of formed spaces,
wherein said plurality of formed spaces are contoured to fit a building material,
wherein a friction force of said cradle prevents said building material from moving about said plurality of formed spaces,
a bolster assembly to which said cradle is removeable secured, said bolster assembly comprising:
a beam having a first end, second end, top surface, bottom surface, and sides,
wherein a bottom of said cradle is configured to make contact with at least one of said top surface and said bottom surface,
end plates attached to said first end and second end of said beam,
wherein said end plates extend past at least one of said top surface and said bottom surface,
wherein said end plates comprise a plurality of attachment holes for securing said cradle thereto,
wherein said end plates contact said cradle when said cradle is placed on at least one of said top surface and said bottom surface,
wherein said end plates have a height less than said height of said cradle when said cradle is placed on at least one of said top surface and said bottom surface,
at least two gusset plates attached to said sides of said beam,
wherein said gusset plates extend past at least one of said top surface and said bottom surface,
wherein said gusset plates comprise a plurality of attachment holes for securing said cradle thereto,
wherein said gusset plates contact said cradle when said cradle is placed on at least one of said top surface and said bottom surface,
wherein said gusset plates have a height less than said height of said cradle when said cradle is placed on at least one of said top surface and said bottom surface,
a D-ring attached to an exterior surface of said end plates, and a securing member,
wherein said securing member is used to secure a plurality of bolster assemblies to one another via said D-ring.

2. The system of claim 1, wherein said end plates and said gusset plates extend past only one of said top surface and said bottom surface to create said bolster assembly for a end unit.

3. The system of claim 2, further comprising a vehicle having a flatbed, wherein at least two of said end units are attached to said flatbed via said bolster assembly such that they are parallel, wherein said formed spaces of said cradles of said end units align in order to contour to a building material placed therein.

4. The system of claim 3, further comprising a bolster assembly adapter connected to said flatbed via pockets, wherein slots of said bolster assembly adapter allow for said bolster assembly to be removably secured thereto.

5. The system of claim 1, wherein said end plates and said gusset plates extend past both said top surface and said bottom surface to create said bolster assembly for an internal unit.

6. The system of claim 5, wherein a first internal unit and a second internal unit are placed on top of a first cradle and a second cradle, wherein said first cradle and said second cradle have a parallel orientation, wherein said building material is partially encased within said formed spaces of said first cradle and said second cradle, wherein said formed spaces of said first cradle and said second cradle are aligned in order to contour to said building material placed therein, wherein said formed spaces of said first internal unit and a second internal unit are contoured to fit said building material not encased within said first cradle and said second cradle.

7. The system of claim 1, wherein said securing member is a chain, wherein said chain is woven through said D-ring of said plurality of bolster assemblies in a way that secures said plurality of bolster assemblies to one another.

8. The system of claim 7, wherein said securing member is configured to attach to a flatbed train car.

9. A system for securing a building material comprising:
a cradle having a plurality of formed spaces,
wherein said plurality of formed spaces are contoured to fit a building material,
wherein a friction force of said cradle prevents said building material from moving about said plurality of formed spaces, a bolster assembly to which said cradle is removeable secured, said bolster assembly comprising:
a beam having a first end, second end, top surface, bottom surface, and sides,
wherein a bottom of said cradle is configured to make contact with at least one of said top surface and said bottom surface of said beam,
end plates attached to said first end and second end of said beam,
wherein said end plates extend past at least one of said top surface and said bottom surface,
wherein said end plates comprise a plurality of attachment holes for securing said cradle thereto,
wherein said end plates contact said cradle when said cradle is placed on at least one of said top surface and said bottom surface,
wherein said end plates have a height less than said height of said cradle when said cradle is placed on at least one of said top surface and said bottom surface,
stiffener plates attached to said sides of said beam and said end plates,
wherein said stiffener plates extend past at least one of said top surface and said bottom surface,
wherein said stiffener plates comprise a plurality of attachment holes for securing said cradle thereto,
wherein said stiffener plates contact said cradle when said cradle is placed on at least one of said top surface and said bottom surface and secured thereto via said plurality of attachment holes,
wherein said stiffener plates have a height less than said height of said cradle when said cradle is placed on at least one of said top surface and said bottom surface,
a D-ring attached to an exterior surface of said end plates.

10. The system of claim 9, wherein said end plates and said stiffener plates extend past only one of said top surface and said bottom surface to create said bolster assembly for a end unit.

11. The system of claim 10, further comprising a vehicle having a flatbed, wherein at least two of said end units are attached to said flatbed via said bolster assembly such that they are parallel, wherein said formed spaces of said cradles of said end units align in order to contour to a building material placed therein.

12. The system of claim 11, further comprising a bolster assembly adapter connected to said flatbed via pockets, wherein slots of said bolster assembly adapter allow for said bolster assembly to be removably secured thereto.

13. The system of claim 9, wherein said end plates and said stiffener plates extend past both said top surface and said bottom surface to create said bolster assembly for an internal unit.

14. The system of claim 13, wherein a first internal unit and a second internal unit are placed on top of a first cradle and a second cradle, wherein said first cradle and said second cradle have a parallel orientation, wherein said building material is partially encased within said formed spaces of said first cradle and said second cradle, wherein said formed spaces of said first cradle and said second cradle are aligned in order to contour to said building material placed therein, wherein said formed spaces of said first internal unit and a second internal unit are contoured to fit said building material not encased within said first cradle and said second cradle.

15. The system of claim 9, further comprising a chain, wherein said chain is woven through said D-ring of a plurality of bolster assemblies in a way that secures said plurality of bolster assemblies to one another.

16. The system of claim 15, wherein said chain is configured to attach to a flatbed train car.

17. A system for securing a building material comprising:
a vehicle having a flatbed,
an end unit comprising,
a bolster assembly having a beam, a plurality of attachment plates, and D-ring,
wherein said plurality of attachment plates extend from one of a top surface and a bottom surface,
a cradle contoured to fit a building material and secured to said plurality of attachment plates,
an interior unit comprising,
said bolster assembly having said beam, said plurality of attachment plates, and said D-ring,
wherein said plurality of attachment plates extend from said top surface and said bottom surface,
said cradle contoured to fit said building material and secured to said plurality of attachment plates on both said top surface and said bottom surface, said building material,
wherein at least two of said end unit is secured to said vehicle,
wherein a first layer of building material is placed within said cradle of said end units attached to said vehicle,
wherein at least one interior layer comprising said interior unit and said building material is placed on top of said first layer, and
wherein at least two of said cradle of said end unit is placed on top of said at least one interior layer.

18. The system of claim 17, further comprising a chain, wherein said chain is threaded through said D-ring of said end unit and said interior unit and secured to said vehicle.

19. The system of claim 17, wherein at least two of said end units are attached to a flatbed of said vehicle via said bolster assembly such that said end units are parallel, wherein formed spaces of said cradles of said end units align in order to contour to said building material placed therein.

20. The system of claim 19, further comprising a bolster assembly adapter connected to said flatbed via pockets, wherein slots of said bolster assembly adapter allow for said bolster assembly to be removably secured thereto.
